(19) United States
(12) Patent Application Publication
(10) Pub. No.: US 2023/0339760 A1
(43) Pub. Date: Oct. 26, 2023

(54) METHOD FOR PREPARING GRAPHENE BY MECHANICAL EXFOLIATION AND APPLICATION THEREOF

(71) Applicants: GUANGDONG BRUNP RECYCLING TECHNOLOGY CO., LTD., Foshan (CN); HUNAN BRUNP RECYCLING TECHNOLOGY CO., LTD., Changsha (CN); HUNAN BRUNP VEHICLES RECYCLING CO., LTD., Changsha (CN)

(72) Inventors: Jianfeng Xu, Foshan (CN); Qian Lin, Foshan (CN); Xiaofeng Wu, Foshan (CN); Yuan Wang, Foshan (CN); Dingshan Ruan, Foshan (CN); Changdong Li, Foshan (CN)

(21) Appl. No.: 18/212,680

(22) Filed: Jun. 21, 2023

Related U.S. Application Data
(63) Continuation of application No. PCT/CN2021/142386, filed on Dec. 29, 2021.

(30) Foreign Application Priority Data
Jan. 27, 2021 (CN) 202110111522.9

(51) Int. Cl. C01B 32/19; C01B 32/225; C01B 32/196; H01M 4/583

(52) U.S. Cl. CPC C01B 32/19; C01B 32/225; C01B 32/196; H01M 4/583; C01B 2204/22

(57) ABSTRACT

The invention discloses a method for preparing graphene by mechanical exfoliation and application thereof. The method includes the following steps of: (1) dispersing graphite raw material in a foaming agent aqueous solution to obtain a graphite pre-dispersing solution; and (2) subjecting the graphite pre-dispersing solution to milling, washing with water, and centrifugal classification, to obtain the graphene; wherein the foaming agent aqueous solution includes the following components: sodium alpha-olefin sulfonate, sodium alcohol ether sulphate, diethanolamine coconut fatty acid, polyethylene glycol, and water. In the invention, the foaming agent produce a large amount of stable and fine foam in a closed milling cavity, which can produce jostle effect, support the graphite, and increase the contact area between the graphite and the milling medium, so as to achieve good exfoliation effect.

### CROSS-REFERENCE TO RELATED APPLICATIONS

The present application is a continuation application of PCT application No. PCT/CN2021/142386 filed on Dec. 29, 2021, which claims the benefit of Chinese Patent Application No. 202110111522.9 filed on Jan. 27, 2021. The contents of all of the aforementioned applications are incorporated by reference herein in their entirety.

### TECHNICAL FIELD

The invention relates to the technical field of graphene, and in particular to a method for preparing graphene by mechanical exfoliation and application thereof.

### BACKGROUND

Graphene is a carbon structure material, and carbon atoms therein are arranged in a planar two-dimensional honeycomb structure in the form of SP² hybridization. Therefore, graphene is considered to be the thinnest material in the world. The special structure endows graphene with excellent optical, electrical, and mechanical properties, so that graphene can be used in many fields such as anti-corrosion coatings, thermal conductive coatings, and conductive additives. Therefore, graphene will be a revolutionary new material in the future.

Preparation methods of graphene can be divided into two categories: exfoliation preparation methods and in-situ generation methods. In the exfoliation preparation methods, graphite, as a raw material, is exfoliated layer by layer under the action of a force, and the force can be a mechanical force, a chemical force, or even a force generated by fluids and gases. The first graphene sheet was obtained by two scientists from the University of Manchester in the United Kingdom using tape to exfoliate highly oriented pyrolytic graphite. It can be seen that the force generated by adhesives is enough to exfoliate graphene from graphite. Because of this pioneering work, the two scientists jointly won the 2010 Nobel Prize in Physics. In the in-situ generation methods, a carbon source (alkanes, alkenes, and other hydrocarbons) is subjected to high-temperature pyrolysis and graphene is grown on a base surface. Typical preparation methods comprise Chemical Vapor Deposition (CVD) and Flash Joule Heating (FJH). The graphene prepared by CVD possesses high quality, thin layer, and controllable size. However, the development of subsequent applications is restricted by high preparation cost and difficulty in transferring graphene from the base surface.

A method for preparing graphene by viscously mechanical shearing and exfoliation is disclosed in the prior art. This method comprises dispersing graphite raw material in a viscous solution, and exfoliating the graphite layer by layer under stirring by the viscous shear force of the viscous solution to obtain graphene. However, the main components of the viscous solution are water-soluble polymers. In order to make the viscous solution have better viscosity, it is usually necessary to add a large amount of water-soluble polymers, which results in that it is difficult to directly separate graphene obtained by exfoliating graphite layer by layer from the viscous solution and a lot of water for cleaning or high-temperature pyrolysis is required to remove non-graphene substances. This preparation method of graphene reduces preparation cost, while increases the difficulty and processing cost of extracting graphene from viscous substances, which is unfavorable for large-scale production.

A method for rapidly preparing high-quality graphene is also disclosed in the prior art. This method comprises mixing and ball milling graphite powder with a solid intercalation agent that can be completely decomposed into gas after being heated, heating the intercalation agent appropriately, and then heating the resulting mixture by microwave. The intercalation agent is heated and decomposed into gas, and gas molecules penetrate into graphite flakes and overcome the van der Waals's force between layers so as to exfoliate the graphite. This method has a simple preparation process and low manufacturing cost. However, the distance between layers of graphite is 0.335 nm, only a small amount of the gas molecules generated by heating the solid intercalation agent can penetrate into gaps between the layers of graphite, and effective exfoliation cannot be achieved. The graphene obtained by this method possesses unstable quality and low yield, which is not conducive to large-scale promotion.

### SUMMARY

The invention aims to solve at least one of the aforementioned technical problems existing in the prior art. For this purpose, the invention provides a method for preparing graphene by mechanical exfoliation which is simple, green and economical, and application thereof.

In an aspect of the invention, a method for preparing graphene by mechanical exfoliation is provided, which comprises steps of:
(1) Dispersing graphite raw material in a foaming agent aqueous solution to obtain a graphite pre-dispersing solution; and
(2) Subjecting the graphite pre-dispersing solution to milling, washing with water and centrifugal classification, to obtain the graphene; and
the foaming agent aqueous solution includes following components: sodium alpha-olefin sulfonate, sodium alcohol ether sulphate, diethanolamine coconut fatty acid, polyethylene glycol, and water.

In some embodiments of the invention, the foaming agent aqueous solution includes the following components in parts by weight: 1˜10 parts of sodium alpha-olefin sulfonate, 1˜10 parts of sodium alcohol ether sulphate, 5˜15 parts of diethanolamine coconut fatty acid, 10˜20 parts of polyethylene glycol, and 60˜80 parts of water.

In some embodiments of the invention, the polyethylene glycol has a molecular weight of 2000˜6000.

In some embodiments of the invention, a solid-to-liquid ratio of the graphite raw material to the foaming agent aqueous solution is 10˜15 mg/mL.

In some embodiments of the invention, the graphite raw material is at least one selected from a group consisting of natural flake graphite, microcrystalline graphite, graphite oxide, expandable graphite, artificial graphite, and highly oriented pyrolytic graphite.

In some embodiments of the invention, the centrifugal classification comprises carrying out centrifugation at a centrifugal speed of 1000˜3000 rpm for 1 to 10 min to obtain a supernatant containing graphene. The centrifugal classification can remove non-graphene substances.

In some embodiments of the invention, the milling is carried out by a sand mill, and the sand mill operates at a stirring speed of 500˜2000 rpm. The sand mill is easy to operate and has high portability.

In some embodiments of the invention, the milling may be carried out by a ball mill.

In some embodiments of the invention, the milling is carried out by the sand mill for 0.1˜10 hours.

In some embodiments of the invention, a milling medium of the sand mill has a particle size of 0.3˜3 mm and a loading content of 70%˜80%.

In some embodiments of the invention, the sand mill operates at a temperature of 30˜80° C.

The invention also provides use of the method in preparation of catalysts or battery active materials.

A preferable embodiment of the invention has at least the following beneficial effects.
1. In the invention, graphite as the raw material is infiltrated in the foaming agent aqueous solution, and then milled; the high-speed stirring of milling equipment drives high-speed movement of the milling medium to create impact, friction and shearing force on the graphite; the foaming agent produce a large amount of stable and fine foam in a closed milling cavity, which can produce jostle effect, support the graphite, and increase the contact area between the graphite and the milling medium, so as to achieve good exfoliation effect.
2. The foaming agent aqueous solution prepared in the invention is a compounded system composed of multiple surfactants, has better foam properties than that of a single surfactant, and can produce a large amount of stable foam, which cannot be achieved by ordinary surfactants.
3. Graphene is prepared in a completely physical way in the invention, without involving a chemical oxidation-reduction process, so that the intrinsic structure of graphite is maintained to the greatest extent, and the obtained graphene has properties of thin sheets, few defects, and a certain degree of dispersion stability.
4. The preparation method of the invention is simple, the source of raw materials is wide, the cost is low, and the environmental pollution is small; in addition, the prepared graphene is easy to separate from the substrate, and continuous scale production of the graphene can be realized by high-speed milling equipment that can provide continuous shear force.

### BRIEF DESCRIPTION OF DRAWINGS

The invention will be further described below in conjunction with the accompanying drawings and examples, in the drawings:

FIG. 1 is an SEM image showing morphology of graphite raw material in Example 1 of the invention;

FIG. 2 is an SEM image showing morphology of graphene prepared in Example 1 of the invention;

FIG. 3 is a TEM image of graphene prepared in Example 1 of the invention;

FIG. 4 is a TEM image showing a sheet edge of graphene prepared in Example 1 of the invention;

FIG. 5 is an XRD diffraction pattern of graphene prepared in Example 1 of the invention and graphite raw material;

FIG. 6 is a Raman spectrum of graphene prepared in Example 1 of the invention;

FIG. 7 shows dispersion effects of graphene prepared in Example 1 of the invention in a water/isopropanol mixed solvent; and

FIG. 8 is an SEM image showing morphology of graphene prepared in Comparative Example 1 of the invention.

### DETAILED DESCRIPTION

Hereinafter, the concept of the invention and the technical effects produced by the invention will be described clearly and completely with reference to examples, so as to fully understand the purposes, features and effects of the invention. Obviously, the described examples are only a part of the examples of the invention, rather than all of them. Based on the examples of the invention, other examples obtained by those skilled in the art without creative work shall fall into the scope of protection of the invention.

### Example 1

A method for preparing graphene in this example comprises the following steps of:
(1) Mixing sodium alpha-olefin sulfonate, sodium alcohol ether sulphate, diethanolamine coconut fatty acid, polyethylene glycol 5000, and water in a mass ratio of 4:4:8:15:69 to obtain a foaming agent aqueous solution;
(2) Pre-dispersing artificial graphite uniformly in the foaming agent aqueous solution obtained above to obtain an artificial graphite pre-dispersing solution with a concentration of 10 mg/mL;
(3) adding the artificial graphite pre-dispersing solution into a rod pin sand mill with a milling medium having a particle size of 0.5 mm and a loading content of 80%, and subjecting it to milling for 2 hours at a stirring speed of 1500 rpm; and
(4) subjecting the resulting solution above to washing with water and centrifugation for 10 minutes at a centrifugal speed of 1000 rpm to obtain a supernatant containing graphene, so as to obtain graphene.

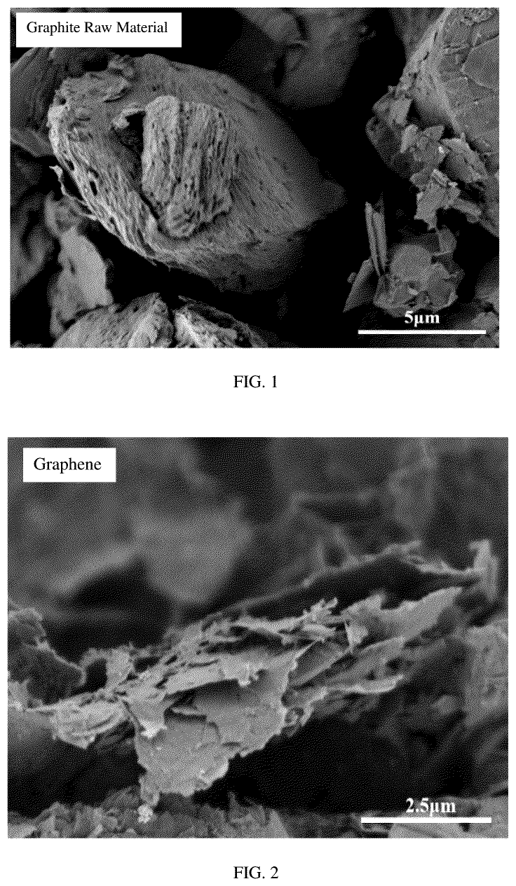

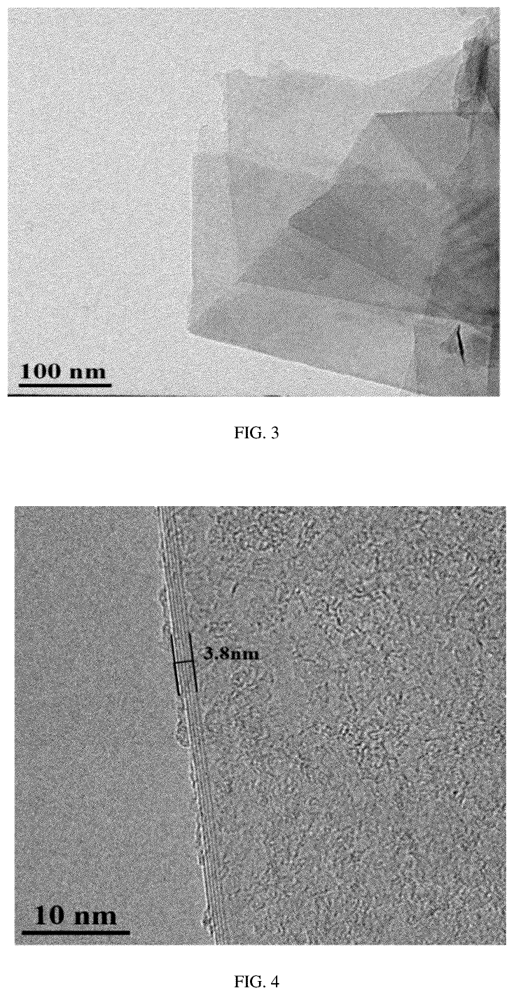

From the morphology of graphite raw material shown by an SEM image in FIG. 1, it can be observed that the artificial graphite has a clear graphite stack structure and a thickness close to 6 μm, so that the artificial graphite can be called as a bulk or granular material. Graphene shown in FIG. 2 is obtained by exfoliation in the above method, it can be seen that graphite thinning is obvious and the graphite is exfoliated into graphene which has a thickness in nanometer level, so that it can be used as a nanometer material; in addition, the graphene has special two-dimensional conductivity, so that it can be an excellent carrier for catalysts and active materials. For the specific thickness of the graphene, from TEM analysis of the exfoliated graphene sheets as shown in FIG. 3 and a partial enlargement of the edge of the graphene as shown in FIG. 4, it can be found that the graphene has lattice fringe at 3.8 nm, indicating that the graphene has a thickness value less than 5 nm.

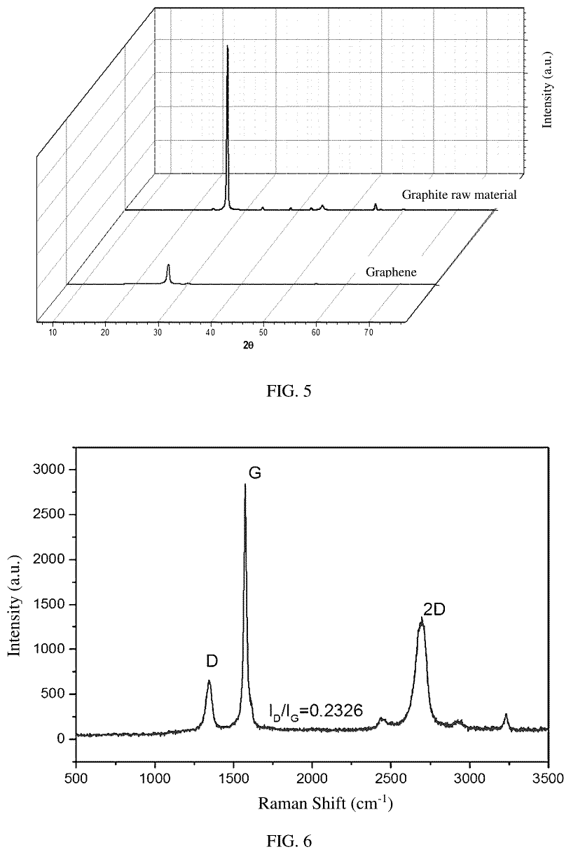

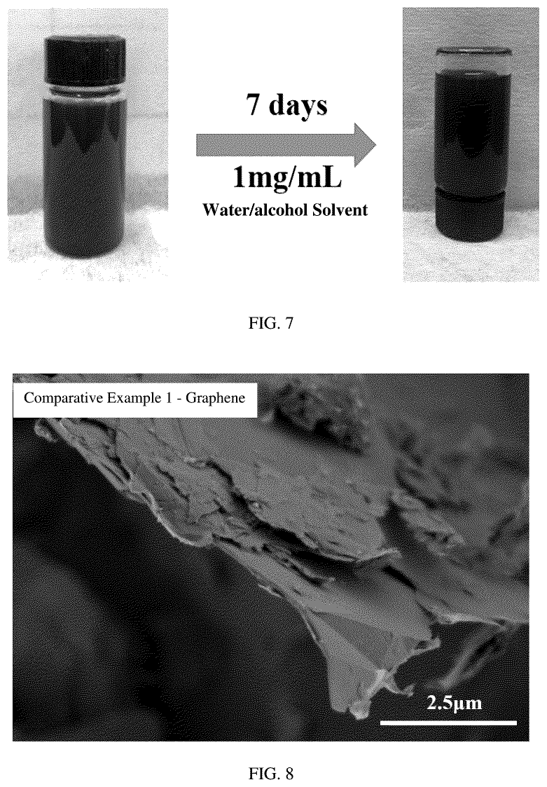

The plane of graphite obtained by stacking along a C-axis direction is the crystal plane (002), corresponding to about 26.4° in the XRD pattern (FIG. 5), with a very strong diffraction peak. After exfoliation, the stacking structure of graphite along the C-axis direction is destroyed, and the sheets are thinned, showing a weak peak of 26.4° as shown in FIG. 5. After the graphite is exfoliated by sanding, the defect value produced can be analyzed by Raman spectrum, and the result is shown in FIG. 6. The graphene exfoliated by this method has a defect concentration ID/IG of 0.2326, which is slightly larger than that of the raw material (ID/IG<0.1) and smaller than that of graphene prepared by a redox method (ID/IG >0.5). The dispersibility test is performed on the exfoliated graphene. As shown in FIG. 7, a 1 mg/mL graphene dispersing solution (water/isopropanol) is obtained by ultrasonic treatment, and after it was allowed to stand for a week, the container is turned upside down, and precipitation at the bottom of the container is observed. It can be found that after standing for 7 days, the graphene still maintains good dispersibility, and there is only a small amount of graphene at the bottom of the container. This is because the graphene sheets are thin and can be more stably dispersed in a solvent which has comparative surface tension to the graphene.

The above results indicate that artificial graphite can be effectively exfoliated by the method of the example, and the prepared graphene has properties of thin sheets, few defects, and a certain degree of dispersion stability.

### Example 2

A method for preparing graphene in this example comprises the following steps of:
(1) Mixing sodium alpha-olefin sulfonate, sodium alcohol ether sulphate, diethanolamine coconut fatty acid, polyethylene glycol 4000, and water in a mass ratio of 5:2.5:7.5:15:70 to obtain a foaming agent aqueous solution;
(2) Pre-dispersing flake graphite uniformly in the foaming agent aqueous solution obtained above to obtain a flake graphite pre-dispersing solution with a concentration of 10 mg/mL;
(3) adding the flake graphite pre-dispersing solution into a rod pin sand mill with a milling medium having a particle size of 0.3 mm and a loading content of 80%, and subjecting it to milling for 2 hours at a stirring speed of 1500 rpm; and
(4) subjecting the resulting solution above to washing with water and centrifugation for 7 minutes at a centrifugal speed of 2000 rpm to obtain a supernatant containing graphene, so as to obtain graphene.

### Example 3

A method for preparing graphene in this example comprises the following steps of:
(1) Mixing sodium alpha-olefin sulfonate, sodium alcohol ether sulphate, diethanolamine coconut fatty acid, polyethylene glycol 3000, and water in a mass ratio of 3:2:5:15:75 to obtain a foaming agent aqueous solution;
(2) Pre-dispersing expandable graphite uniformly in the foaming agent aqueous solution obtained above to obtain an expandable graphite pre-dispersing solution with a concentration of 10 mg/mL;
(3) adding the expandable graphite pre-dispersing solution into a rod pin sand mill with a milling medium having a particle size of 0.8 mm and a loading content of 80%, and subjecting it to milling for 3 hours at a stirring speed of 1000 rpm; and
(4) subjecting the resulting solution above to washing with water and centrifugation for 5 minutes at a centrifugal speed of 2500 rpm to obtain a supernatant containing graphene, so as to obtain graphene.

### Example 4

A method for preparing graphene in this example comprises the following steps of:
(1) Mixing sodium alpha-olefin sulfonate, sodium alcohol ether sulphate, diethanolamine coconut fatty acid, polyethylene glycol 4000, and water in a mass ratio of 3:2:5:15:75 to obtain a foaming agent aqueous solution;
(2) Pre-dispersing microcrystalline graphite uniformly in the foaming agent aqueous solution obtained above to obtain a microcrystalline graphite pre-dispersing solution with a concentration of 10 mg/mL;
(3) Adding the microcrystalline graphite pre-dispersing solution into a rod pin sand mill with a milling medium having a particle size of 2 mm and a loading content of 80%, and subjecting it to milling for 4 hours at a stirring speed of 1000 rpm; and
(4) Subjecting the resulting solution above to washing with water and centrifugation for 5 minutes at a centrifugal speed of 3000 rpm to obtain a supernatant containing graphene, so as to obtain graphene.

### Comparative Example 1

A method for preparing graphene in this example differs from that in Example 1 in that the components of the foaming agent aqueous solutions are different, and comprises the following specific steps of:
(1) Mixing sodium alpha-olefin sulfonate and water in a mass ratio of 4:96 to obtain a foaming agent aqueous solution;
(2) Pre-dispersing artificial graphite uniformly in the foaming agent aqueous solution obtained above to obtain an artificial graphite pre-dispersing solution with a concentration of 10 mg/mL;
(3) Adding the artificial graphite pre-dispersing solution into a rod pin sand mill with a milling medium having a particle size of 0.5 mm and a loading content of 80%, and subjecting it to milling for 2 hours at a stirring speed of 1500 rpm; and
(4) Subjecting the resulting solution above to washing with water and centrifugation for 10 minutes at a centrifugal speed of 1000 rpm to obtain a supernatant containing graphene, so as to obtain graphene.

The biggest difference between Comparative Example 1 and Example 1 is that the components of the foaming agent aqueous solutions are different. The components, diethanolamine coconut fatty acid and polyethylene glycol 5000, of the foam agent aqueous solution in Example 1 have thickening and foam stabilizing effects. Due to lack of polymers with thickening and foam stabilizing effects in the foaming agent aqueous solution of Comparative Example 1, the resulting foam is unstable and easily broken, resulting in poor mechanical exfoliation effect and low graphene yield. Referring to FIG. 8, from the SEM image showing morphology of graphene prepared in Comparative Example 1, it can be further found that the exfoliated graphene still maintains a thicker sheet with a thickness in a range from 10 to 100 nm, which is obviously different from the graphene prepared in Example 1. According to the definition and classification of graphene, the graphene prepared in Comparative Example 1 can be considered to be graphene nanosheets or graphite microsheets. Correspondingly, the key indicators of the graphene in Comparative Example 1 is systematically compared with that of the graphite raw material and the graphene in Example 1, and the results are shown in Table 1.

TABLE 1

| | Yield | BET (m²/g) | I_{D}/I_{G} | Thickness (nm) | |
|---|---|---|---|---|---|
| Graphite raw material | 0 | 2.6 | 0.03 | 5~10 | μm |
| Comparative Example 1 | 10% | 13.5 | 0.12 | 10~100 | nm |
| Example 1 | 65% | 80.5 | 0.23 | 5~10 | nm |

It can be seen from Table 1 that because the foaming agent aqueous solution in Comparative Example 1 lacks a foaming aid, a thickener, and a foam stabilizer, the resulting foam is unstable and is insufficient in fineness, so that the exfoliated graphene is inferior to the graphene of Example 1 in yield, thickness and morphology.

The result of Comparative Example 1 shows that when the foaming agent aqueous solution is a single-component surfactant with a certain foaming effect, although foam can be produced, the foam is unstable and easily broken, resulting in poor mechanical exfoliation of graphite. In the invention, the foaming agent aqueous solution is a compounded system, so that the resulting foam is stable and fine, and maintains functions of surfactants, thereby increasing the mechanical exfoliation effect of the graphite.

The examples of the invention are described in detail above with reference to the accompanying drawings. However, the invention is not limited to the above-mentioned examples. Within the scope of knowledge possessed by those of ordinary skill in the art, various modifications can be made without departing from the purpose of the invention. In addition, in the case of no conflict, the examples of the invention and the features in the examples can be combined with each other.

1. A method for preparing graphene by mechanical exfoliation, wherein the method comprises steps of:
(1) dispersing graphite raw material in a foaming agent aqueous solution to obtain a graphite pre-dispersing solution; and
(2) subjecting the graphite pre-dispersing solution to milling, washing with water and centrifugal classification, to obtain the graphene; and
the foaming agent aqueous solution comprises following components: sodium alpha-olefin sulfonate, sodium alcohol ether sulphate, diethanolamine coconut fatty acid, polyethylene glycol, and water; the foaming agent aqueous solution comprises the following components in parts by weight: 1˜10 parts of sodium alpha-olefin sulfonate, 1˜10 parts of sodium alcohol ether sulphate, 5˜15 parts of diethanolamine coconut fatty acid, 10˜20 parts of polyethylene glycol, and 60˜80 parts of water; a solid-to-liquid ratio of the graphite raw material to the foaming agent aqueous solution is 10˜15 mg/mL.

2. The method of claim 1, wherein the polyethylene glycol has a molecular weight of 2000˜6000.

3. The method of claim 1, wherein the graphite raw material is at least one selected from a group consisting of natural flake graphite, microcrystalline graphite, graphite oxide, expandable graphite, artificial graphite, and highly oriented pyrolytic graphite.

4. The method of claim 1, wherein the milling is carried out by a sand mill, and the sand mill operates at a stirring speed of 500˜2000 rpm.

5. The method of claim 4, wherein the milling is carried out by the sand mill for 0.1˜10 hours.

6. The method of claim 4, wherein a milling medium of the sand mill has a particle size of 0.3˜3 mm and a loading content of 70%˜80%.

7. The method of claim 1, wherein the centrifugal classification comprises carrying out centrifugation at a centrifugal speed of 1000˜3000 rpm for 1 to 10 min to obtain a supernatant containing graphene.

8. Use of a method of claim 1 in preparation of catalysts or battery active materials.

9. Use of a method of claim 2 in preparation of catalysts or battery active materials.

10. Use of a method of claim 3 in preparation of catalysts or battery active materials.

11. Use of a method of claim 4 in preparation of catalysts or battery active materials.

12. Use of a method of claim 5 in preparation of catalysts or battery active materials.

13. Use of a method of claim 6 in preparation of catalysts or battery active materials.

14. Use of a method of claim 7 in preparation of catalysts or battery active materials.
